(19) United States
(12) Patent Application Publication
(10) Pub. No.: US 2026/0313611 A1
(43) Pub. Date: Oct. 8, 2026

(54) PAGING FOR AMBIENT INTERNET OF THINGS DEVICES

(71) Applicant: InterDigital Patent Holdings, Inc., Wilmington, DE (US)

(72) Inventors: Mohamad Kenan Al-Hares, Canterbury (GB); Michael Starsinic, Newtown, PA (US); Guanzhou Wang, Brossard (CA); Saad Ahmad, Montreal (CA)

(73) Assignee: InterDigital Patent Holdings, Inc., Wilmington, DE (US)

(21) Appl. No.: 19/481,635

(22) PCT Filed: May 10, 2024
(86) PCT No.: PCT/US2024/028785

§ 371 Date: Nov. 5, 2025

Related U.S. Application Data
(60) Provisional application No. 63/465,778, filed on May 11, 2023.

(51) Int. Cl. H04W 68/02

(52) U.S. Cl. CPC H04W 68/02

(57) ABSTRACT

Network communications may be performed using paging procedures. A wireless transmit/receive unit (WTRU) may initiate the paging with an on-demand paging procedure. The WTRU may determine to transmit a first indication that the WTRU is ready to initiate an on-demand paging procedure. The WTRU may transmit, to at least one network entity, the first indication. The WTRU may receive, from the at least one network entity, a second indication that there is downlink data pending for the WTRU. In response to a determination that downlink data is pending for the WTRU, the WTRU may listen to a paging channel. The WTRU may determine that a paging occasion is set for the WTRU. The WTRU may read a paging message. In response to determining that the paging message includes an identifier that is associated with the WTRU, the WTRU may perform a service request procedure to receive the downlink data.

### CROSS-REFERENCE TO RELATED APPLICATIONS

This application claims the benefit of U.S. Provisional Patent Application No. 63/465,778 filed on May 11, 2023, the entire contents of which are incorporated herein by reference.

### BACKGROUND

Paging is a procedure that allows the network to reach the wireless transmit/receive unit (WTRU) when the WTRU is in an inactive or idle state. Current paging techniques might fall short with ambient IoT devices which have power constraints. In addition, using current techniques to page ambient IoT devices may be wasteful for network resources.

### SUMMARY

A wireless transmit receive unit (WTRU) may determine to initiate an on-demand paging procedure. The WTRU may send a first indication associated with initiating the on-demand paging procedure to at least one network entity. The first indication may comprise a request for a system information block. For example, the first indication may identify a particular system information block. The WTRU may receive the system information block from the at least one network entity. The system information block may indicate whether the WTRU should continue the on-demand paging procedure. The WTRU may monitor a paging channel for a second indication in a paging occasion, for example, in response to the system information block indicating that the WTRU should continue the on-demand paging procedure. The second indication may indicate whether the paging occasion is set. The system information block may include a bit that indicates whether the WTRU should monitor the paging channel. For example, the bit may indicate whether there is downlink data pending for the WTRU. The system information block may indicate that the WTRU should continue the on-demand paging procedure when the bit indicates that there is downlink data pending for the WTRU. The system information block may indicate that the WTRU should return to a low power state when the bit indicates that there is no downlink data pending for the WTRU. The WTRU may receive a paging message via the paging channel.

In some examples, the WTRU may receive configuration information associated with the on-demand paging procedure. The configuration information may comprise one or more of: a condition associated with initiating the paging procedure, a timer value associated with initiating the paging procedure, an allowed location, and/or an indication of the system information block. The determination to initiate the on-demand paging procedure may be based on one or more of the configuration information, an expiration of a timer, detecting that the WTRU has enough power to perform the on-demand paging procedure, or detecting that the WTRU is in an allowed location. The WTRU may perform a service request procedure to receive the downlink data based on the paging message comprising an identifier associated with the WTRU. The service request procedure may include the WTRU transitioning to a connected state and receiving the downlink data.

### BRIEF DESCRIPTION OF THE DRAWINGS

FIG. 1A is a system diagram illustrating an example communications system in which one or more disclosed embodiments may be implemented.

FIG. 1B is a system diagram illustrating an example wireless transmit/receive unit (WTRU) that may be used within the communications system illustrated in FIG. 1A according to an embodiment.

FIG. 1C is a system diagram illustrating an example radio access network (RAN) and an example core network (CN) that may be used within the communications system illustrated in FIG. 1A according to an embodiment.

FIG. 1D is a system diagram illustrating a further example RAN and a further example CN that may be used within the communications system illustrated in FIG. 1A according to an embodiment.

FIG. 2 is an example of a paging procedure in a network.

FIG. 3 is an example of a WTRU-initiated on-demand paging.

### DETAILED DESCRIPTION

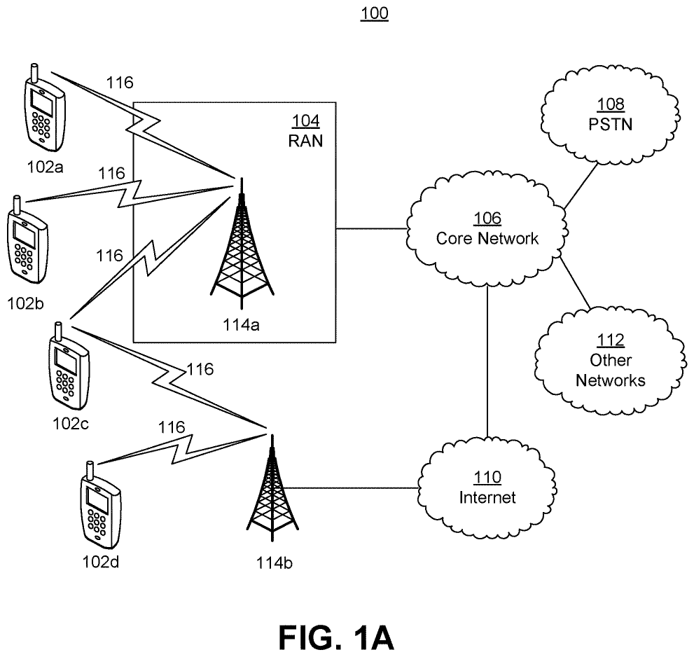

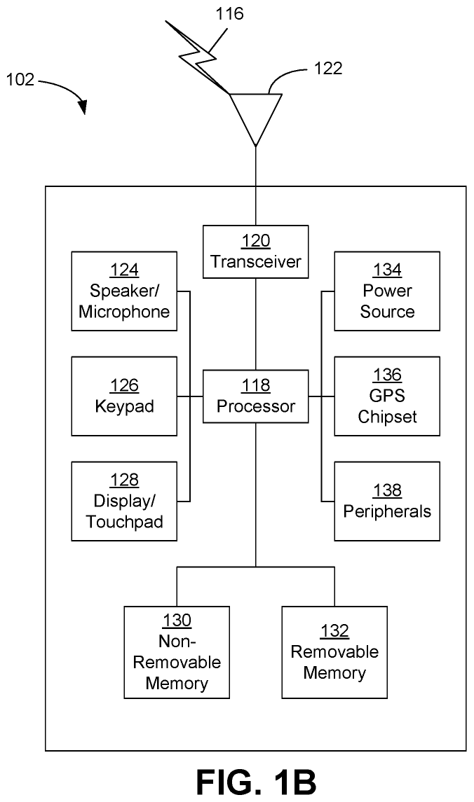

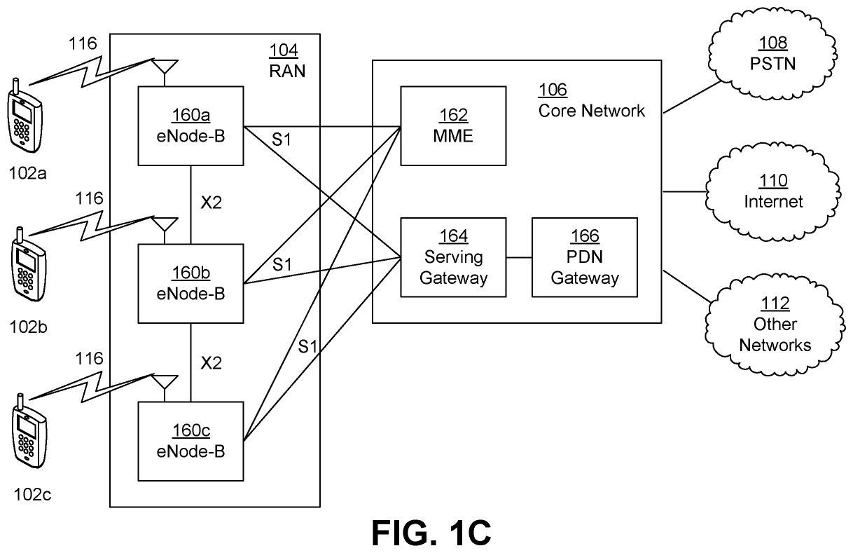

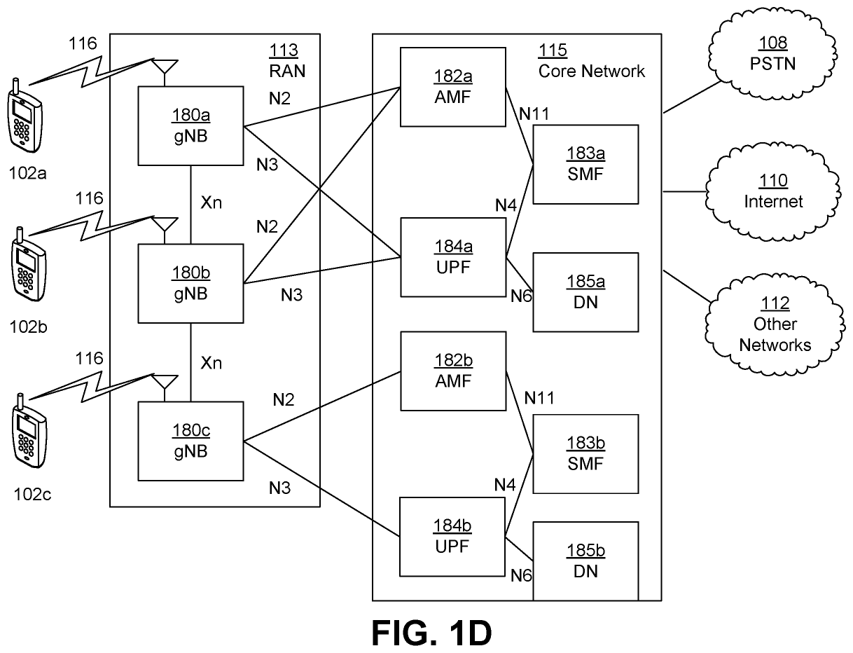

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word ofdm (UW-OFDM), resource block-filtered ofdm, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a WTRU. Further, any description herein that is described with reference to a UE may be equally applicable to a WTRU (or vice versa). For example, a WTRU may be configured to perform any of the processes or procedures described herein as being performed by a UE (or vice versa).

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., a eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QOS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit 139 to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the UL (e.g., for transmission) or the downlink (e.g., for reception).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80×80 configuration. For the 80×80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80×80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like.

Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating WTRU IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-ab, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may perform testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

An ambient Internet of Things (IoT) device (e.g., a WTRU) may be configured with information used to determine when to transmit a signal to a base station. The signal may identify a group of which the WTRU belongs to. The purpose of the signal may be to trigger the base station to begin to broadcast an indication. The purpose of the indication may be so that the WTRU can read the indication to determine whether to perform a procedure where the WTRU checks if it is being paged. An advantage of this procedure is that, if the signal indicates that the WTRU does not need to perform a procedure where the WTRU checks if it is being paged, then the WTRU can enter a low power state. Another advantage of this procedure is that, if the WTRU does need to be paged, the network does not need to attempt to transmit the page until it receives the signal from the ambient IoT device.

Methods and embodiments described herein may be performed by an Access and Mobility Function (AMF). These operations may be performed by any network function that provides mobility management functionality in a network that provides communication services to Ambient IoT devices.

Methods and embodiments described herein may be performed by a Session Management Function (SMF). These operations may be performed by any network function that provides session management functionality in a network that provides communication services to Ambient IoT Devices.

Methods and embodiments described herein may be performed by a Radio Access Network (RAN) Node, gNodeB, or Base Station. These operations may be performed by any base station that communicates with Ambient IoT Devices.

System information request messages may be used in a paging procedure. A system information request message may be a type of message that may be sent from a WTRU to a base station. A system information request may request that the base station broadcast certain information. The system information request may indicate what information is requested to be broadcasted. Information may be transmitted in a System Information Block (SIB). A SIB may include information that is broadcasted by a base station. The same information that is proposed to be sent may also be sent in any message that is broadcast by a base station. Events described herein may trigger a service request. A service request may be a procedure that is used by the WTRU to request to enter a connected state to receive downlink data and/or to enter a connected state to send uplink data.

Non-access Stratum (NAS) messages may be sent from a WTRU to a network and/or received by a WTRU from a network. These messages may be sent over other protocols that are used to send control information between a WTRU and a network (e.g. a core network). Radio resource control (RRC) messages may be sent from a WTRU to a RAN Node and received by a WTRU from a RAN Node. These messages may be sent over other protocols that are used to send control information between a WTRU and a base station. The terms base station, gNB, NG-RAN, RAN, and RAN Node may be used interchangeably.

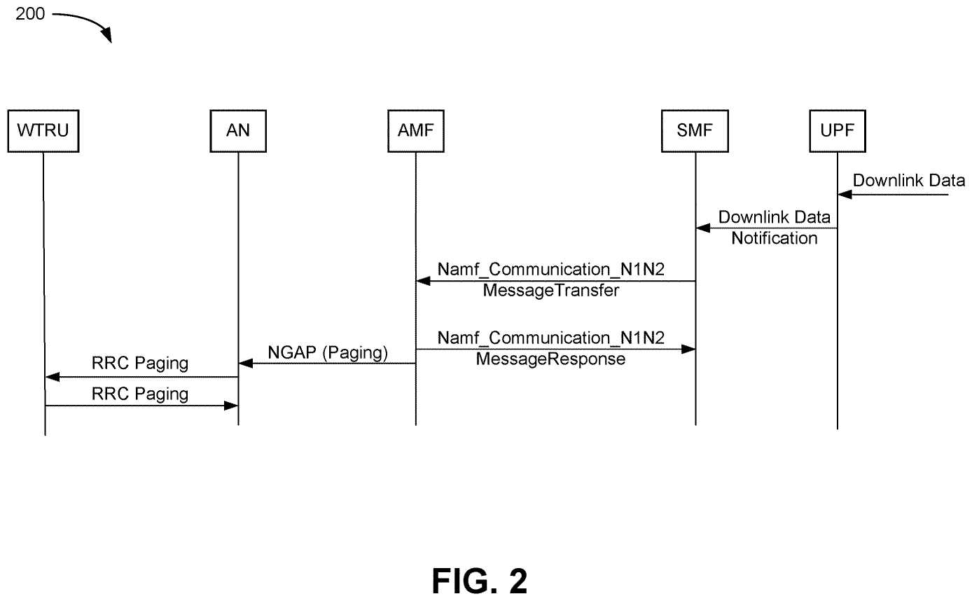

FIG. 2 is an example of a paging procedure 200 in a network. Paging is a procedure that may allow the network to reach the WTRU when the WTRU is in an inactive or idle state. While the WTRU goes to the idle mode, the last known gNB the WTRU attached to (e.g., anchor gNB) may save the WTRU core context information. Discontinuous Reception (DRX) may allow the WTRU to shut down for specific period of time before waking up and decoding the Paging Occasion (PO) to check if there is any paging message toward the WTRU and/or in which Resource Block/s the message may be sent. As shown in FIG. 2, when there is incoming data from the User Plane Function (UPF), the SMF may notify the AMF about the arriving traffic utilizing Namf_Communication_N1N2MessageTransfer Request. The AMF may trigger the gNB with NG application protocol (NGAP) paging message. Considering the DRX, the gNB may page the WTRU using the Paging Occasion (PO) on the PDCCH channel. The WTRU may decode the PDCCH traffic for any paging information every cycle, which may be resource wasteful if the WTRU has no data to receive.

Early paging indications may be implemented to reduce the power consumption in the WTRU by using the early paging indication. In examples, an Early Paging Indicator (EPI) may be sent to the WTRU over downlink control information (DCI) or the reference signal, so the WTRU checks the next PO for paging instead of decoding each PO sent during the waking time. When the EPI is received by the WTRU, the WTRU may get ready to decode the next received PO.

Sub-grouping may be implemented to reduce the false paging notification rate as wide range of WTRUs has the same PO or group of inactive WTRUs has the same EPI. This may reduce the power consumption in the WTRU. The sub-group information may be sent alongside the EPI over DCI where the WTRU group is divided into Subgroups. This may allow the WTRU to figure out if to decode the next PO.

While the described paging techniques may work efficiently with WTRUs that do not have certain power constraints (e.g., extreme power constraints), these techniques may fall short with ambient IoT devices which have certain power constraints (e.g., extreme power constraints). Using these techniques to page ambient IoT devices may be wasteful for network resources. Certain paging procedures may present drawbacks when they are considered with ambient IoT devices. WTRUs with extreme power constraints may have relatively little energy storage capacity compared to other WTRUs and/or energy storage components of the WTRU that may include batteries or other energy storage devices that may be charged at unknown and/or infrequent times. Some IoT devices (e.g., WTRUs) having extreme power constraints may be battery-less and/or use a capacitor for energy storage. Some IoT devices (e.g., WTRUs) having extreme power constraints may use energy harvesting techniques in order to store energy in a component such as a battery or a capacitor. When some energy harvesting techniques are used (e.g., vibration energy harvesting or RF energy harvesting) the IoT devices (e.g., WTRUs) having extreme power constraints may harvest as little as few microwatts of energy. The amount of energy that can be obtained in a typical energy harvesting scenario for WTRUs having extreme power constraints may be much less than other WTRUs that can obtain energy from other sources (e.g., a phone charger). For example, some WTRU charges may consume over 10 Watts. Furthermore, a WTRU that uses energy harvesting techniques may harvest energy at unpredictable times. For example, a WTRU that harvests energy from vibrations may harvest energy when the WTRU vibrates (e.g., when the WTRU is moved).

When implementing paging techniques, devices may listen for a paging indication at assigned paging occasions. Ambient IoT devices may rely on harvesting power from the environment and may not have enough power stored to listen to a paging indication at an assigned paging occasion.

When a WTRU does not respond to a page, the network may assume that the WTRU's location has changed and expand the paging area (e.g., the number of cells over which the paging message is transmitted). This approach may not be implemented well for ambient IoT devices. The paging indication may have been transmitted in the correct location, but the ambient IoT device may be unresponsive because the ambient IoT device does have enough energy stored to receive the paging message. Thus, this approach may be wasteful of network resources (e.g., paging resources) when applied to ambient IoT devices. Thus, paging procedures may be implemented to account for the unreliable nature of an ambient IoT device's power supply and to efficiently manage network resources.

Embodiments are described herein for paging ambient IoT devices. The WTRU may initiate a paging request towards the network when the WTRU has enough power and is triggered by certain conditions. The embodiments described herein may reduce signaling and/or power consumption in the WTRU and transmission resources and signaling in the network. The embodiments described herein may be enablers in scenarios where there is a highly dense and widely spread population of ambient devices attached to the network.

An ambient IoT device (e.g., a WTRU) may be configured with information that the WTRU may use to determine when to transmit a signal to a base station. The signal may identify the group that the WTRU belongs to. The signal may to trigger the base station to begin to broadcast an indication. The indication may be provided such that the WTRU may read the indication to determine whether to perform a procedure where the WTRU checks if it is being paged.

If the signal indicates that the WTRU does not need to perform a procedure where the WTRU checks if it is being paged, then the WTRU may enter a low power state. If the WTRU does need to be paged, the network may not attempt to transmit the page until the network receives the signal from the ambient IoT device.

The WTRU may determine to initiate an on-demand paging procedure. The determination may be based on configuration information that was received in a NAS or RRC message. The determination may be based on expiration of a timer and detecting that the WTRU has enough power to perform an on-demand paging procedure. The determination may be based on detecting that the WTRU is in an allowed location.

The WTRU may transmit a message that indicates to a network a request to broadcast information. The content of the message may be based on configuration information that was received in a NAS or RRC message. The content of the message may include a group identifier or a paging-listening-identifier. The message may be a system information on-demand request message wherein the system information on-demand request message identifies a SIB and the identified SIB is based on the configuration information.

The WTRU may receive a message that was broadcasted by the network, wherein at least part of the message is used by the WTRU to determine whether to continue with an on-demand paging procedure. The content of the message may be an SIB. The content of the message may include a group identifier that is associated with the WTRU. The content of the message includes a bit that represents a group that the WTRU is associated with and/or that indicates if a WTRU of the group is to be paged. The content of the message may include an identifier of the WTRU.

Based on the content of the message that was broadcasted by the network, the WTRU may determine to transmit a message to the network to continue with an on-demand paging procedure and/or to determine if the WTRU is being paged.

The WTRU may initiate a paging procedure by sending an indication to the network indicating that the WTRU is awake. The indication may or may not specifically identify the WTRU. The indication may identify a group or a service that the WTRU belongs to. The network may determine if the network is to page any WTRU that is associated with the group and, if the network does intend to page any WTRU that is associated with the group, the network may begin to broadcast an indication that at least one WTRU from the group needs to receive a paging message. This example procedure may be called “on-demand paging” because the paging message may be sent upon a demand, or request, from the WTRU.

For Ambient IoT devices, the network may queue the data and/or send the paging request to the RAN. The RAN, for example a RAN Node, may queue the paging request until a system information request is sent by the WTRU. This may be a WTRU-initiated paging procedure as the WTRU may control the start of the paging process.

The SMF may receive a downlink data notification from the UPF. The downlink data notification may trigger the SMF to notify the AMF that there is downlink data available for the WTRU. The message from the SMF may indicate to the AMF that the WTRU, AMF, and RAN may execute an on-demand paging procedure if the WTRU is in the CM-IDLE state. The SMF may determine that an on-demand paging procedure may be used based on the PCC Rules. Alternatively, or additionally, the AMF may determine that an on-demand paging procedure may be used based on the WTRU's subscription information. If the WTRU is in the CM-IDLE state, the AMF may respond to the SMF with an indication that the WTRU is currently unreachable and that the on-demand paging procedure will be performed. The AMF may assume that the WTRU is unreachable because the WTRU is in the CM-IDLE state and, based on the determination to use an on-demand paging procedure, the WTRU cannot be paged. The AMF may then send a paging request to the RAN node. The paging request may include the WTRU identity and/or may indicate to the RAN node that an on-demand paging procedure may be performed.

When the WTRU determines that the WTRU has enough power stored to receive and process data from the network and/or is triggered by certain conditions, the WTRU may determine to perform an on-demand paging procedure with the network. The WTRU may transmit a system information on-demand request to the network which requests that the network broadcast a paging-group SIB. The paging-group SIB may include the group identifier for which one or multiple WTRUs are to be paged, or each bit of the paging-group SIB may represent a group of devices and/or the network may set the corresponding bit in the SIB if the network desires to page one or multiple WTRU(s) of the group. If the WTRU reads the SIB and determines that the bit of the SIB that corresponds to its group is set, then the WTRU may begin to listen to a paging channel. If the WTRU reads the SIB and does not find its group identifier or determines that the bit of the SIB that corresponds to its group is not set, then the WTRU may return to a sleep state.

If the WTRU reads the paging channel and determines that its assigned paging occasion is set, then the WTRU may read a paging message. If the WTRU reads the paging channel and determines that its assigned paging occasion is not set, then the WTRU may return to a sleep state. If the WTRU reads the paging message and finds an identifier in the paging message that is assigned to the WTRU, then the WTRU may determine to perform service request procedure in order to receive mobile terminated data. If the WTRU reads the paging message and does not find an identifier in the paging message that is assigned to the WTRU, then the WTRU may return to a sleep state.

The WTRU may determine whether to spend energy attempting to read a paging indicator. The determination may be based on reading a SIB. The network may avoid setting the SIB until the system information on-demand request is received. By waiting to set the WTRU's paging occasion until after the system information on-demand request is received, the likelihood of other WTRUs detecting a false page may be avoided.

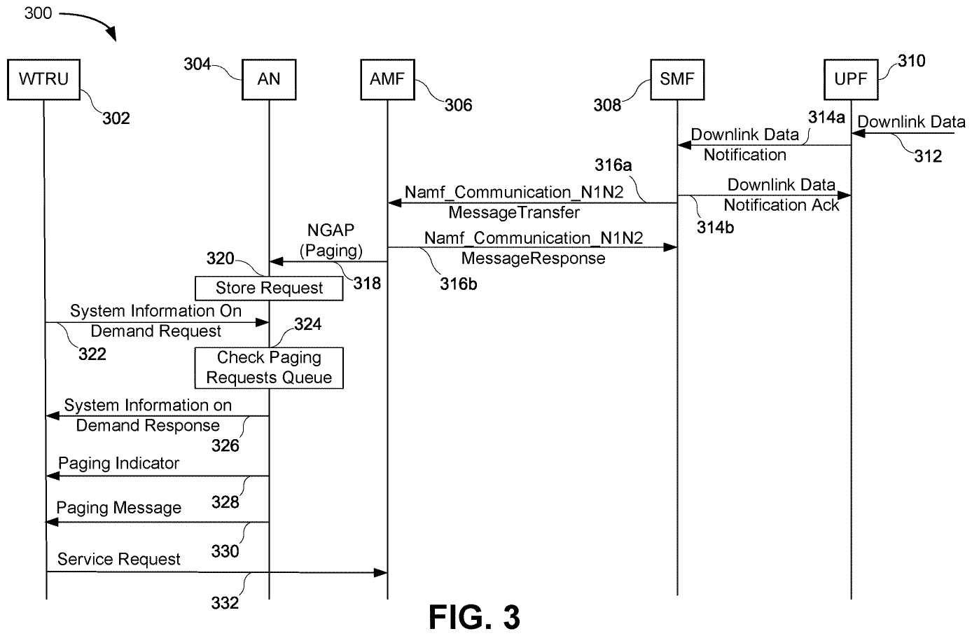

FIG. 3 depicts a call flow diagram for a WTRU-initiated on-demand paging 300. At 312, an UPF 310 may receive downlink data. At 314a, upon receiving the downlink data, the UPF 310 may send a downlink data notification to a SMF 308. At 314b, the SMF 308 may acknowledge receiving the notification and may inform the UPF 310 to store the downlink data as a WTRU 302 is using on-demand paging. The UPF 310 may store the downlink data (e.g., user data), for example, until the UPF 310 receives a notification from the SMF 308 that the WTRU 302 is ready to receive the downlink data. At 316a, the SMF 308 may send a message to the AMF 306 to notify the AMF 306 that there is downlink data available for the WTRU 302. The message sent at 316a may indicate that the AMF 306 is to execute an on-demand paging procedure, for example, if the WTRU 302 is in an idle state (e.g., the CM-IDLE state). In examples, the message sent at 316a may be an Namf_Communiation_N1N2MessageTransfer request.

At 316b, the AMF 306 may send a response message to the SMF 308 in response to the message received at 316a. The response message sent at 316b to the SMF 308 may indicate that the WTRU 302 is in the CM-IDLE state and/or that an on-demand paging procedure will be performed. At 318, the AMF 306 may send a paging message to a RAN Node (e.g., the AN 304). The paging message may include an identifier of the WTRU 302 and an indication that the on-demand paging procedure should be performed. The paging message may include a group ID. The group ID may be used by the RAN node (e.g., the AN 304) to determine what SIB and/or what bit of the SIB may be used to indicate to the WTRU 302 that mobile terminated data is available for the WTRU 302. Additionally or alternatively, the identifier of the WTRU 302 may be used (e.g., by the AN 304) to determine what SIB and/or what bit of the SIB may be used to indicate to the WTRU 302 that mobile terminated data is available for the WTRU 302.

At 320, the RAN node (e.g., AN 304) may store the paging request and may wait for an indication from the WTRU 302 that the WTRU 302 is available to receive the page.

The WTRU 302 may determine to initiate an on-demand paging procedure. At 322, one or more events and/or conditions may trigger the WTRU 302 to initiate the on-demand paging procedure. For example, the determination to initiate the on-demand paging procedure may be based on (e.g., triggered by) one or more of the configuration information, an expiration of a timer, detecting that the WTRU 302 has enough power to perform the on-demand paging procedure, and/or detecting that the WTRU 302 is in an allowed location. The configuration information may be associated with the on-demand paging procedure and may have been received from the network (e.g., the AN 304). The configuration information may include a condition associated with initiating the paging procedure, a timer value associated with initiating the paging procedure, an allowed location, and/or an indication of the system information block. The WTRU 302 may send, at 322, a System Information On-Demand request to at least one network entity (e.g., AN 304). The request may include an indication associated with the on-demand paging procedure. For example, the System Information On-Demand request may indicate a request for the RAN node (e.g., AN 304) to broadcast a particular SIB. The request may identify the SIB. For example, the request from the WTRU 302 may identify a SIB comprising a bit that indicates to the WTRU 302 whether there is downlink data pending for the WTRU 302. For example, the bit may indicate whether the WTRU 302 should monitor a paging channel. The events and/or conditions that trigger the WTRU 302 to send the System Information On-Demand request to the network (e.g., AN 304) are described herein. The RAN Node (e.g., AN 304) may receive, at 322, the System Information On-Demand request from the WTRU 302. Based on both receiving the System Information On-Demand request and based on the notification from the AMF 306 that there is downlink data pending for the WTRU 302, the RAN Node (e.g., AN 304) may set a paging indicator that is associated with the WTRU 302.

Based on receiving the System Information On-Demand request, the RAN node (e.g., AN 304) may begin to broadcast, at 326, the SIB that indicates whether the WTRU 302 should continue the on-demand paging procedure. For example, the SIB may include a bit which indicates to the WTRU 302 whether there may be downlink data pending for the WTRU 302, for example, whether the WTRU should continue the on-demand paging procedure (e.g., monitor a paging channel). The SIB may indicate that the WTRU 302 should continue the on-demand paging procedure when the bit indicates that there is downlink data pending for the WTRU 302.

At 326, the WTRU 302 may receive the SIB that indicates whether the WTRU 302 should continue the on-demand paging procedure and may detect the state of the bit that indicates to the WTRU whether there may be downlink data pending for the WTRU 302. For example, the AN 304 may send, at 326, a system information on demand response message to the WTRU 302. If the state of the bit indicates that there is no downlink data pending for the WTRU 302, the WTRU 302 may return to a sleep or low-power state (e.g. CM-IDLE state). If the state of the bit indicates that there is downlink data pending for the WTRU 302, the WTRU 302 may continue the on-demand paging procedure and may listen, at 328, to a paging channel. For example, the WTRU 302 may monitor the paging channel for a second indication in a paging occasion in response to the SIB indicating that the WTRU 302 should continue the on-demand paging procedure. The second indication may indicate whether the paging occasion is set.

If the WTRU 302 reads the paging channel and determines that its assigned paging occasion is set, the WTRU 302 may receive, at 330, a paging message from the AN 304. If the WTRU 302 reads the paging channel and determines that its assigned paging occasion is not set, the WTRU may return to a sleep state. At 330, the WTRU 302 may read the paging message. The WTRU 302 may perform, at 332, a service request procedure to receive the downlink data based on the paging message comprising an identifier associated with the WTRU 302. The service request procedure may include the WTRU 302 transitioning to a connected state and/or the WTRU 302 receiving the downlink data. For example, the WTRU 302 may determine whether the paging message comprises the identifier associated with the WTRU 302. If the WTRU 302 determines that the paging message includes an identifier that is associated with the WTRU 302, the WTRU 302 may perform, at 332, the service request procedure with the network in order to move into a connected state and/or begin receiving the downlink data. For example, the WTRU 302 may send, at 332, a service request to the AMF 306. If the WTRU 302 determines that the paging message does not include an identifier that is associated with the WTRU 302, the WTRU 302 may return to a sleep state.

There are several events and conditions for the WTRU to trigger the on-demand paging procedure. The WTRU may receive configuration information related to the on-demand paging procedure. The configuration information may be received from the AMF in a NAS message, the policy control function (PCF) in a NAS message (e.g. carried in a NAS message), the base station in an RRC message, a user interface (e.g., a graphical user interface (GUI), button, or switch), and/or another WTRU (e.g., via sidelink such as PC5).

The parts of the configuration information may be received by the WTRU from different network nodes. For example, configuration information from the AMF may indicate how often to perform on-demand paging procedure when the on-demand paging procedure is enabled and configuration information from the base station may indicate if the on-demand paging procedure is enabled. The configuration information may include information that indicates what conditions need to be met in order for the WTRU to perform the on-demand paging procedure. The configuration information may include a timer value. The WTRU may use the time value to configure a timer. The WTRU may reset the timer each time the WTRU is in a connected mode or initiates an on-demand paging procedure. The WTRU may determine to perform the paging procedure if the timer has expired. Thus, the time value can be used to configure the WTRU such that the number of on-demand paging procedures that are attempted by the WTRU is limited in the time domain.

The configuration information may include allowed location information or unallowed location information. The WTRU may determine not to initiate an on-demand paging procedures when the WTRU determines that WTRU is in a location that corresponds to the unallowed location information. The WTRU may determine to initiate an on-demand paging procedures when the WTRU determines that it is in a location that corresponds to the allowed location information.

The configuration information may indicate to the WTRU which SIB, and/or which bit of the SIB, the WTRU should read when the WTRU checks if it needs to be paged. The WTRU may determine to initiate an on-demand paging procedure by sending an appropriate system information on-demand request when the WTRU determines that the WTRU has enough power stored to perform the procedure. The WTRU may receive downlink data and determine that the conditions that were indicated in the configuration information indicate that an on-demand paging procedure is permitted (e.g., permitted in the WTRU's current location or at the current time). The WTRU may determine to initiate an on-demand paging procedure by sending an appropriate system information on-demand request when the WTRU determines that the WTRU has enough power stored to perform the procedure and/or receive downlink data and/or received a trigger message from other WTRU via sidelink (e.g., PC5).

There are alternative approaches to initiating the on-demand paging procedure. The WTRU may initiate the on-demand paging procedure by transmitting a system information on-demand request. The WTRU may alternatively transmit a different message to initiate the on-demand paging procedure. For example, the WTRU may initiate the on-demand paging procedure by transmitting a message that includes a paging-listening-identifier. The Identifier may be associated with the WTRU and also other WTRUs (e.g., the identifier may be shared by a group of WTRUs). The paging-listening-identifier may be received by the WTRU in the configuration information related to the on-demand paging procedure. The RAN may determine which SIB to broadcast based on paging-listening-identifier. An advantage to transmitting a paging-listening-identifier to initiate the process instead of transmitting a system on-demand information request, may be that a fake, or malicious, base station would not know the SIB number to broadcast in response to the WTRU's transmission of the paging-listening-identifier.

There are alternative deployment models. The examples described herein explain how an ambient IoT device may communicate with a base station in order to determine if the ambient IoT device is to receive data from the network. The same procedures may be applied in a scenario where the ambient IoT device interacts with a WTRU such as a handheld device that is used to collect data from Ambient IoT Devices and send data to Ambient IoT Devices. For example, the interaction in FIG. 3 that is described as occurring between the WTRU and base station may instead take place between the Ambient IoT Device and WTRU over a PC5 interface. Additionally or alternatively, the interaction between the Ambient IoT Device and WTRU may be used by the Ambient IoT Device to determine if the WTRU is being paged. Once the Ambient IoT Device determines that it is being paged, the Ambient IoT Device may initiate contact with the network by sending a service request to the network. In other words, 322 through 330 of the procedure of FIG. 3 may take place between the Ambient IoT Device and handheld device whereas 332 may take place between the Ambient IoT Device and the Network.

What is claimed is:

1-20. (canceled)

21. A method implemented by a wireless transmit receive unit (WTRU), the method comprising:
determining to initiate an on-demand paging procedure;
sending, to at least one network entity, a first indication associated with initiating the on-demand paging procedure, the first indication comprising a request for system information;
receiving, from the at least one network entity, the system information indicating whether the WTRU should continue the on-demand paging procedure;
in response to the system information indicating that the WTRU should continue the on-demand paging procedure, monitoring a paging channel for a second indication in a paging occasion; and
receiving the second indication via the paging channel during the paging occasion.

22. The method of claim 21, further comprising receiving configuration information associated with the on-demand paging procedure, wherein the configuration information comprises one or more of a condition associated with initiating the paging procedure, a timer value associated with initiating the paging procedure, an allowed location, or an indication of the system information.

23. The method of claim 22, wherein the determination to initiate the on-demand paging procedure is based on one or more of the configuration information, an expiration of a timer, detecting that the WTRU has enough power to perform the on-demand paging procedure, or detecting that the WTRU is in an allowed location.

24. The method of claim 21, wherein the system information comprises a bit that indicates whether the WTRU should monitor the paging channel, wherein the bit indicates whether there is downlink data pending for the WTRU.

25. The method of claim 24, wherein the system information indicates that the WTRU should continue the on-demand paging procedure when the bit indicates that there is downlink data pending for the WTRU.

26. The method of claim 24, wherein the system information indicates that the WTRU should return to a low power state when the bit indicates that there is no downlink data pending for the WTRU.

27. The method of claim 21, wherein the first indication associated with initiating the on-demand paging procedure identifies a particular system information.

28. The method of claim 21, wherein the second indication indicates whether the paging occasion is set.

29. The method of claim 21, further comprising performing a service request procedure to receive downlink data based on the second indication comprising an identifier associated with the WTRU.

30. The method of claim 29, wherein performing the service request procedure comprises transitioning to a connected state, the method further comprising receiving the downlink data.

31. A wireless transmit receive unit (WTRU), comprising:
a processor configured to:
determine to initiate an on-demand paging procedure;
send, to at least one network entity, a first indication associated with initiating the on-demand paging procedure to at least one network entity, the first indication comprising a request for system information;
receive the system information from the at least one network entity, the system information indicating whether the WTRU should continue the on-demand paging procedure;
in response to the system information indicating that the WTRU should continue the on-demand paging procedure, monitor a paging channel for a second indication in a paging occasion; and
receive the second indication via the paging channel during the paging occasion.

32. The WTRU of claim 31, wherein the processor is further configured to receive configuration information associated with the on-demand paging procedure, wherein the configuration information comprises one or more of a condition associated with initiating the paging procedure, a timer value associated with initiating the paging procedure, an allowed location, or an indication of the system information.

33. The WTRU of claim 32, wherein the determination to initiate the on-demand paging procedure is based on one or more of the configuration information, an expiration of a timer, detecting that the WTRU has enough power to perform the on-demand paging procedure, or detecting that the WTRU is in an allowed location.

34. The WTRU of claim 31, wherein the system information comprises a bit that indicates whether the WTRU should monitor the paging channel, wherein the bit indicates whether there is downlink data pending for the WTRU.

35. The WTRU of claim 34, wherein the system information indicates that the WTRU should continue the on-demand paging procedure when the bit indicates that there is downlink data pending for the WTRU.

36. The WTRU of claim 34, wherein the system information indicates that the WTRU should return to a low power state when the bit indicates that there is no downlink data pending for the WTRU.

37. The WTRU of claim 31, wherein the first indication associated with initiating the on-demand paging procedure identifies a particular system information.

38. The WTRU of claim 31, wherein the second indication indicates whether the paging occasion is set.

39. The WTRU of claim 31, wherein the processor is further configured to perform a service request procedure to receive downlink data based on the second indicator comprising an identifier associated with the WTRU.

40. The WTRU of claim 39, wherein performing the service request procedure comprises the processor being configured to transition to a connected state, wherein the processor is further configured to receive the downlink data.
